(19) United States
(12) Patent Application Publication
(10) Pub. No.: US 2019/0243821 A1
(43) Pub. Date: Aug. 8, 2019

(54) METHOD AND SYSTEM FOR HIGH PERFORMANCE DATA MATCHING AND MATCH SET GROUPING

(71) Applicant: IBIS, LLC, New Boston, NH (US)

(72) Inventors: Bruce Duhamel, Weare, NH (US); Eric Ely, Goffstown, NH (US); James St. Jean, Francestown, NH (US)

(21) Appl. No.: 16/252,852

(22) Filed: Jan. 21, 2019

Related U.S. Application Data
(60) Provisional application No. 62/626,811, filed on Feb. 6, 2018.

(51) Int. Cl. G06F 16/23; G06F 16/27; G06F 16/2455

(52) U.S. Cl. CPC G06F 16/2379; G06F 16/24558; G06F 16/278

(57) ABSTRACT

In one aspect, a computer-implemented method for partitioning records in a data set, wherein each record has one or more data elements includes comparing the records to identify pairs of matching records in the data set, wherein records within each pair of matching records are representative of a common entity. Each matching record is assigned to a unique partition wherein said unique partition contains all matching records and does not overlap with any other partition. Each record is updated with a partition identifier representative of said unique partition. In another aspect, a computer-based information handling system for resolving and partitioning matching records in a data set is provided.

### CROSS REFERENCE TO RELATED APPLICATION

This application claims the priority benefit of U.S. provisional application No. 62/626,811 filed Feb. 6, 2018. The aforementioned application is incorporated herein by reference in its entirety.

### BACKGROUND

The present disclosure relates generally to the field of data management. In a more limited aspect, the present development relates to match grouping of a plurality of data records within a data set to reduce computational time and complexity in identifying matches among the data records using a computer-based information handling system. In certain embodiments the present development relates to a system and method for matching data records within a data set, each data record containing data elements representative of a business entity, wherein the present system and method may advantageously be used to derive business intelligence information about the entities described by the data records, and the present development will be described herein primarily by way of reference thereto, although it will be recognized that the present development is amenable to for use with entities of any type, including without limitation, persons, employees, customers, vendors, manufacturers, property, equipment and all manner of other items.

### SUMMARY

Business Intelligence and Analytics problems often require efficient matching and linking of very large, loosely coupled data sets in order to build holistic profiles of business entities, such as employers. Current techniques to analyze and link these data sets demand sequential processing in order to prevent data inconsistencies. When operating with relatively large data sets, e.g., data sets in the millions of records with numbers of matches in the tens or hundreds of millions of possibilities, sequential methods are no longer feasible. This is due to exceptionally long processing times with a sequential set of operations. The present disclosure presents a method and system that overcome such problems and others by providing a highly efficient, parallel process for identifying and linking matching records within a data set, which makes the present system and method feasible and practical to carry out on modest computing systems.

Consider a loosely structured data set A that consists of, for example, 10 million records, labeled A1, A2, A3, etc. through A10000000. Distinct records within data set A have variable numbers of populated data elements, for example, record A1 may have 20 populated data elements, while A2 may have 15 populated data elements and A3 may have 30 populated data elements. In the case of data pertaining to business entities, examples of data elements include entity name, address, telephone number, web address, email address, employer identification number (EIN), alternative business name, fax number, employee count, revenue range, year founded, and industry, among others.

Each record in data set A represents profile data (business intelligence) on a particular entity, such as an employer (company). The present development will be described herein primarily by way of reference to a data set relating to one or more businesses or employers, although the present development is not limited to such.

For a given employer represented within the data set, there may be (a) one record in data set A which represents that employer, or (b) more than one record in data set A representing that employer. However, there is no particular identifier within the data itself that decisively identifies the employer to which each record belongs. Instead, the likely identity of an employer associated with a given data record must be evaluated and derived via algorithmic processing.

The process to produce a holistic profile for a particular entity, in this case an employer, represented by data in data set A is to identify which records in data set A relate to the same employer (such as an employer we will label E1), and which relate to other employers (e.g., E2, up to EN). To do this, it is necessary to process each of the data records in data set A and match/link them together, so that all the records determined to be associated with the same employer E1 are linked together within a group G1 (see FIG. 2), wherein there are no data records associated with other employers (E2-EN) in that same group G1. However, in a large data set it is expected that there are other, similar linked groups (i.e., G2-GN) that are associated with other distinct employers for which data records are found within the data set.

The challenge of building these groups is further complicated due to the possibility of record match chaining. Chaining happens when matches such as the following occur:
A1 matches A7
A7 matches A99
A99 matches A207
A99 matches A311
A311 matches A1

In this situation, it is desirable that all of these chains be resolved in order to arrive at the appropriate linked group G1 for a single employer we will call E1, resulting in:

Employer E1=[A1, A7, A99, A207, A311]

Once linked successfully by the appropriate employer identifier, the available profile information (business intelligence) on employer E1 can be derived through examination of the aggregate set of values within the records that are linked to one another because they are associated with the same employer E1. For example, one record might contain an employer identification number (EIN), where another might contain an address, where another (or more than one) might contain phone numbers.

The matching and linking process needed in this case to build profiles for these employers must include a method to compare one record in set A with other records in set A, to determine which ones match each other and, thus, are assumed to be related to the same employer. In loosely structured, sparse data sets such as that described here, there is no definitive method to do this. For example, one cannot simply compare names because one record might have a name, and another may not have a name at all. Alternatively, the names may be different, even though the company is in fact the same, for example if one describes a brand name or fictitious trade name while another describes a legal corporation name. Likewise, phone numbers may or may not match, addresses may or may not match, and so on. Moreover, a particular comparison between two records may come to the conclusion that the two records are not associated with the same employer but instead represent different employers.

There are three primary challenges present in implementing a process capable of deriving employer profiles as outlined here. Those key challenges are:
1. How to efficiently compare records to one another to determine matching relationships;
2. How to resolve and unwind match chains in order to determine complete groups; and
3. How to safely and efficiently assign unique identifiers (e.g., the proper employer identifiers in the case of employer/business entity data) to the related record sets.

To solve a problem such as this on large data sets using non-computational means would be virtually impossible. That is because, to complete the process, it is necessary to compare each record in set A with every other different record in set A, to apply the explicit and fuzzy matching logic and determine the likelihood that the records in each pair of records are related or not and whether that likelihood meets an acceptable threshold for deciding whether or not the records in each pair should be linked to each other. For a data set A with 10 million records, that total number of comparisons is combinatoric and requires up to 49.99 trillion comparisons. Then, chains need to followed and resolved, and, finally, efficient assignment of employer identifiers to each record must be applied.

The method described herein presents a highly efficient approach to match sparsely populated records, as required by step 1, and then to unwind and resolve match chains of arbitrary depth in order to identify non-overlapping record sets, as required in step 2 of this process. The unwinding and resolution process is able to collapse the recursive nature of the chained match data into an efficient sequential processing sequence where match groups are subsequently collapsed into prior match groups when chained matches are encountered.

By application of this particular method, it is possible to execute steps 1 and 3 in a highly parallel manner and thus achieve a high degree of overall performance in solving this type of problem. Sequential processing is isolated to Step 2, which can be executed very efficiently using the present method.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram of an exemplary data set of the type to be processed by the present system and method.

FIG. 2 is a graphical illustration of one set of matches between data records in a data set having N data records.

FIG. 3 illustrates an exemplary manner of representing a match record comprising a pair of matching records in the data set being processed.

FIG. 4 is a flow chart illustrating the manner of partitioning data records using the match records.

FIG. 5 illustrates an exemplary computer-based information handling system operable to embody the present development.

### DETAILED DESCRIPTION OF THE PREFERRED EMBODIMENTS

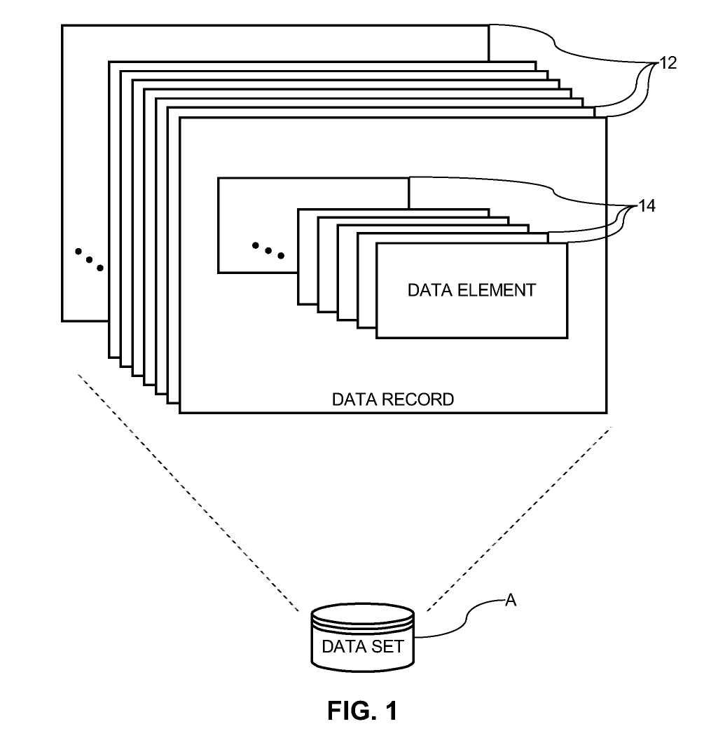

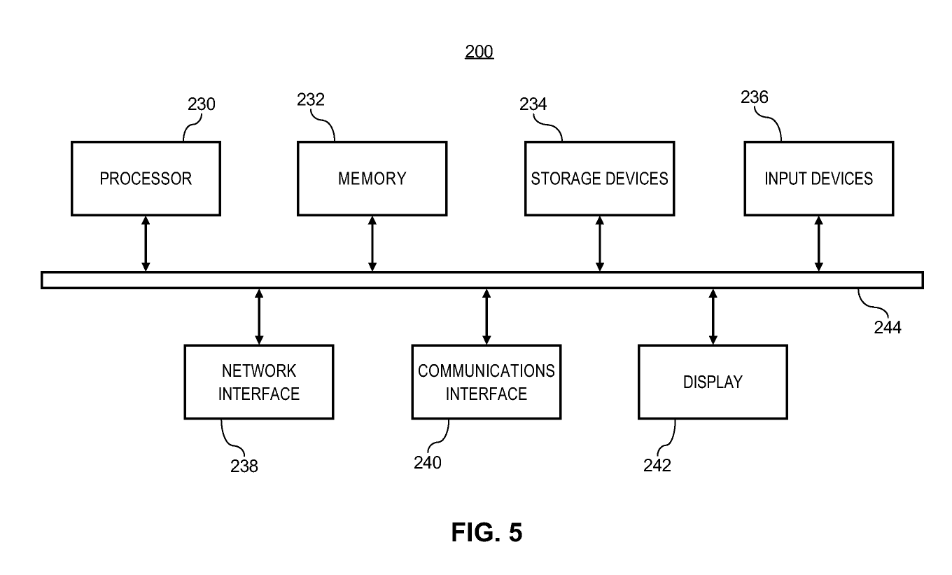

FIG. 1 illustrates the hierarchy of a data set A, which comprises two or more (up to any number N) data records 12. Each data record 12, in turn, contains one or more data elements 14. The data set may be stored in a computer readable memory such as memory 232 (see FIG. 5) associated with a computer-based information handling, such as the exemplary computer-based information handling system 200 illustrated in FIG. 5.

The three steps described above in building business intelligence profiles for entities from loosely structured data sets comprises:
1. Processing and matching all the records in the source data set to produce match records;
2. Following and resolving matches and match chains to produce non-overlapping data groups associated with particular entities represented in the data; and
3. Assigning/writing the appropriate entity identifiers to each of the original source records, the entity identifier representing the entity that the record describes.

Assume we are operating on a set of records “A” with individual record identifiers A1, A2, A3, etc.; the following description outlines the three steps:

### Step 1

In certain embodiments, in Step 1, a high performance yet flexible multi-level comparison method is implemented that is able to predict within some acceptable probability threshold whether or not two records represent the same entity. This comparison method relies on both explicit indicators (such as Record A1 and A7 have data element in common, such as the same phone number), as well as “fuzzy” matching logic, which consists of partial matching, overlapping matching, similarity matching, and other business rules that contribute to making the match prediction. For example, in the case of business entities, and using such fuzzy matching logic, Record A1 and A7 would be determined to represent the same entity of the entity name if the records differed only in the presence or omission of an entity designator such as “Inc.” or “LLC” or truncation of a word, such as “Corporation” vs. “Corp.” The current fuzzy matching rules may also be logically extended to utilize other known matching strategies such as machine learning predictions based on historical examples.

In certain embodiments, the matching process is implemented in a unique multi-staged manner to deliver high performance. The process consists of collecting together likely matches (“match candidates”) from the universe of potential record matches, then utilizing a scoring system to predict the likelihood that the records match the same entity. The stages are as follows:

Stage 1: Quick Matching

This stage implements two fast matching rules to find candidate matches:
a. a pre-computed entity signature (hash table or index of relevant data values in the data record) in order to very quickly identify matching duplicate records; and
b. an address signature (hash table or index of relevant raw or standardized address data values) combined with an exact name match to identify nearly duplicate records.

Stage 2: Field Matching

This stage identifies candidate match records that were not found by Stage 1, but which have at least one common overlapping field, such as employer identification number, phone number, web address, email address, zip code, street address, or the like.

Stage 3: Similarity Matching

This stage identifies candidate matching records that were not found by stages 1 or 2 but are candidates because of some level of name overlap or similarity. The steps are:
a. Normalize business names, e.g., by replacing abbreviations with non-abbreviated words, removing or replacing punctuation, or applying other applicable normalization rules to generate consistent wording between data records;
b. Reduce original and normalized business names to their core keywords and/or filtering out so-called “stop words.” The stop words may be stored in a stop word list stored in an electronically readable memory associated with the computer-based information handling system;
c. Utilize relevance matching on the remaining words from the business names to identify candidate records with highest degree of similarity or overlapping of words; and
d. Apply a configurable limit on the maximum number of records to be allowed from similarity matching in order to retain overall high performance.

Stage 4: Candidate Scoring

For each candidate match record, a flexible scoring system is applied to predict the likelihood that the two records are representative of the same entity. In certain embodiments, the flexible scoring system consists of the following:
a. Calculate a variable name match score based on the level of name similarity/overlap;
b. Calculate a variable address match score based on the level of address similarity/overlap;
c. Adjust the score in the case of Employer Identification Number (EIN) match where the EIN is a valid employer identification number;
d. Calculate a variable phone number match score based on the level of phone number similarity/overlap and when the phone numbers are valid phone numbers;
e. Adjust the score in the case of email, web address, or web domain matching;
f. Apply one or more additional matching business rules, which may adjust the score upward or downward;
g. Adjust the score in the case of industry match or overlap;
h. Reduce the score in the case of one or more non-matching fields which are present in both records, such as EIN, phone number, web domain, industry, employee range, revenue range, etc., that are not consistent with one another; and
i. Finally adjust the score based on the numeric quantity of intersecting data segments, for example, any name matching is one segment, any address matching is a second segment, and so on.

Stage 5: Match Prediction

The last stage makes a prediction based on the scoring factors to determine whether these records represent the same entity. In certain embodiments, the prediction itself has multiple thresholds, which can be selected based on the willingness of the consuming application to accept false positives. For example, in certain applications, it may be desirable to apply a “stricter” threshold, which produces higher confidence matches but might miss some matches. Likewise, in certain embodiments, it may be desirable to apply a “less strict” threshold, which normally predicts a higher number of matches but at a trade-off of letting through a higher rate of errors. In certain embodiments, match threshold level is selectable by the user. In certain embodiments, any number (e.g., 2, 3, 4, 5, 6, or more) of varying selectable matching threshold levels are provided.

For each of the candidate records that is predicted to be a match within the selected risk threshold, the candidate record is treated as a confirmed match. The outcome of comparing all the records against each other using these methods is a list of confirmed record matches of the example form:
A1 matches A7
A7 matches A99
A99 matches A207
A99 matches A311
A311 matches A1
   It will be recognized that the above example is simplified for illustrative purposes. In certain embodiments, there may be many millions of these matches recorded as the output of Step 1 and, in practice, there may be many more match records than original source records.

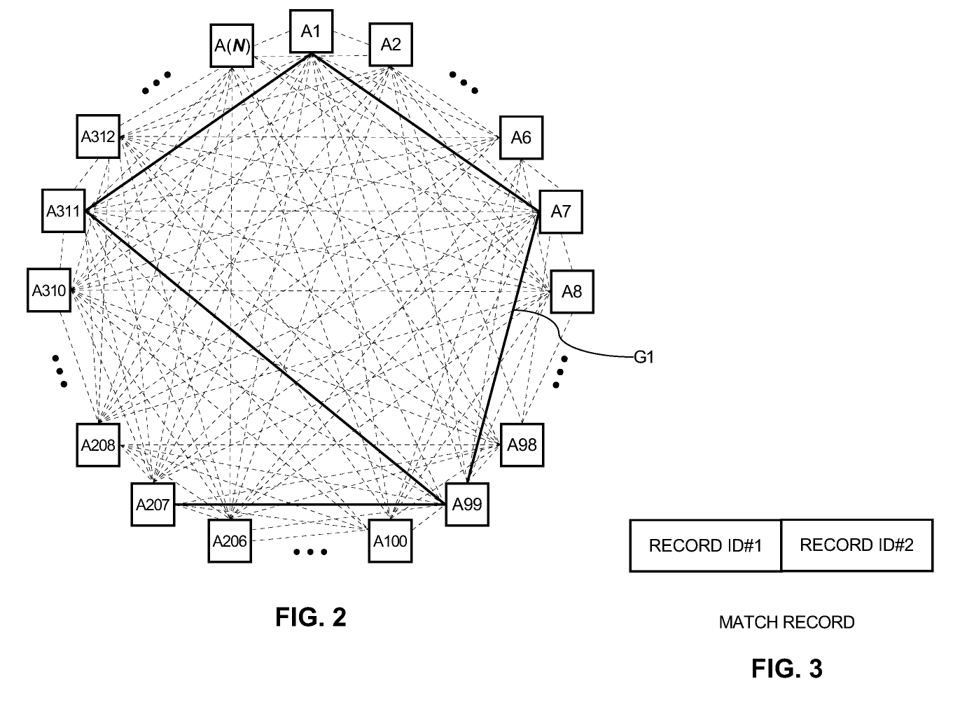

Because Step 1 only identifies and records matches, but does not write any data back to the original source records, it is possible to execute the matching process in a highly parallel manner across a plurality, e.g., 128 or more, of simultaneous processes, where each distinct process is responsible for producing the list of matches for a given subset of the source records contained in the data set. FIG. 2 illustrates the example given above, wherein dashed lines between records represent non-matches and solid lines represent matches. FIG. 2 illustrates a data set having a single match chain ease of exposition, although it is contemplated that a given data set will ordinarily have multiple match chains within it (not shown), i.e., corresponding to other entities or employers.

### Step 2

In Step 2, we will utilize a unique method to process these match chains efficiently and identify sets of non-overlapping record groups for each entity represented in the data. The purpose of Step 2 is to segregate records into distinct, non-overlapping sets so that parallel processing can be performed on each set independently, in order to maximize algorithmic performance and eliminate the possibility of concurrency conflicts that might lead to data corruption.

The method of Step 2 employs a “partitioning algorithm” described as follows. The partitioning algorithm takes a set of match records as input. Each match record is a pair of record identifiers where the left record identifier is deemed a match for the right record identifier. An illustration of a match record representative of a pair of matching records appears in FIG. 3. For example, in certain embodiments, the first match record identified in the example given in Step 1 has the form A1, A7. The object of Step 2 is to assign each match record a unique partition assignment that (1) groups all the matching records in the same partition but (2) does not overlap any other partition.

In Step 2, each subsequent match record produced by Step 1 is processed in sequence. If both records in the pair currently being processed are not in a partition, they are assigned the next available new partition identifier. If one record in the pair is already in a partition, then the second record is assigned the same partition.

By processing the match records in serial fashion to partition records, concurrency issues are avoided, which would manifest themselves if multiple processes were trying to write conflicting partition information into the same records within the data set at the same time. In certain embodiments, the partitioning algorithm herein works by tracking partition assignments in a numeric array indexed by record (as identified by its record ID). The members of each partition are also stored in sets to enable fast merging of partitions when following match chains. This process avoids the normal complexities of following recursive match chains individually.

A partition table is used as an index to determine which partition set to update during partition assignment. In certain embodiments, for utmost computational efficiency, the partition table is a bit array the size of which is set to the largest numerical record ID, however other implementations are possible. Once the partitioning process is complete, the values in the partition table can be used to write the entity identifiers back to the source records in Step 3, discussed in greater detail below.

The following examples explain the operation of the partitioning system. Examples include matches which have the form An₁, An₂ to mean An₁ implies An₂, or more specifically, record An₁ matches record An₂, wherein n₁ and n₂ are numerical data record designations. Assigned partition groups are shown next to records using the symbol “:”. For example An₁:0 means record An₁ is assigned partition 0 and An₂:1 means record An₂ is assigned partition 1. In the illustrated embodiment, partition “0” is a special partition identifier value that indicates that the record has not been partitioned yet. Finally, partition sets are shown in the form “1:{An₁, An₂}” meaning that partition number one contains the data records identified by An₁ and An₂.

In the illustrated embodiments: (a) the presence of a comma (“,”) between a pair of records indicates a match record identified in Step 1; (b) the presence of a dash symbol (“−”) before the pair indicates a match record that has already been processed; and (c) the presence of a colon “:” followed by a number appearing after a data record indicates the partition number to which that data record has been assigned. The process herein is illustrated below, with reference again to the example given above wherein:

A1 matches A7 (A1, A7)

A7 matches A99 (A7, A99)

A99 matches A207 (A99, A207)

A99 matches A311 (A99, A311)

A311 matches A1 (A311, A1).

The following Examples illustrate the process of Step 2.

### Example 1

Example 1 is a simple example wherein an initial partition assignment is made. Starting with an initial match record A1, A7 wherein neither record has yet been partitioned, we have an initial state of:

Matches: A1, A7

Partitions: A1:0 A7:0

Sets: { }.

Because neither A1 nor A7 have yet been assigned a partition group, processing this match record assigns both A1 and A7 to the next available partition identifier, in this case partition 1.

Partitions: A1:1 A7:1

After this step, we have the partition sets:

Sets: 1:{A1, A7}.

### Example 2

Example 2 illustrates a further example, which also considers circular references. Referring again to the example above, consider the following initial state:

Matches: A1,A7 A7,A99 A99,A311 A311,A1

Partitions: A1:0 A7:0 A99:0 A311:0

Sets: { }.

The process first handles the match A1, A7. Since neither record in the match record pair has a partition defined, both records are assigned to the next available partition, namely, partition 1 (note the first match A1, A7 is now shown as having been processed with the “−” prefix designation):

Matches: −A1,A7 A7,A99 A99,A311 A311,A1

Partitions: A1:1 A7:1 A99:0 A311:0

Sets: 1: {A1, A7}.

Now we process the second match, A7, A99, where A7 is already in partition 1, so A99 should also be added to partition 1:

Matches: −A1,A7 −A7,A99 A99,A311 A311,A1

Partitions: A1:1 A7:1 A99:1 A311:0

Sets: 1: {A1, A7, A99}

Now we process the third match, A99, A311, where A99 is already in partition 1, so A311 should be added to partition 1.

Matches: −A1,A7 −A7,A99 −A99,A311 A311,A1

Partitions: A1:1 A7:1 A99:1 A311:1

Sets: 1:{A1, A7, A99, A311}

Lastly, we process the next link, A311:A1, which is a circular reference. Because A311 and A1 are already in the same partition, nothing needs to be changed.

Matches: −A1,A7 −A7,A99 −A99,A311 −A311,A1

Partitions: A1:1 A7:1 A99:1 A311:1

Sets: 1: {A1, A7, A99, A311}

### Example 3

Example 3 looks at a case using matching records from the above example where sets are processed that require partition merges. Consider the following initial state:

Matches: A1,A7 A99,A311 A311,A1

Partitions: A1:0 A7:0 A99:0 A311:0

Sets: { }

The first match record A1, A7 is processed and since neither record is in a partition, A1 and A7 are both added to partition 1:

Matches: −A1,A7 A99,A311 A311,A1

Partitions: A1:1 A7:1 A99:0 A311:0

Sets: 1: {A1, A7}

The second match record A99, A311 is processed and since neither are in a partition, A99 and A311 are both added to the next available partition, which is partition 2:

Matches: −A1,A7 −A99,A311 A311,A1

Partitions: A1:1 A7:1 A99:2 A311:2

Sets: 1:{A1, A7} 2:{A99, A311}

Finally, the third match record A311, A1 is processed and it is determined that both records, though matching, are in different partitions. Because it is an object of Step 2 to assign all matching records into a single, unique partition, the right (e.g., numerically higher) partition (partition 2) is merged into the left (e.g., numerically lower) partition (partition 1). Thus, as a result of the comparison of records A311 and A1, the record A311, as well as all other records in partition 2 (in this example, A99), are merged into partition 1 by changing the partition identifier.

Matches: −A1,A7 −A99,A311 −A311,A1

Partitions: A1:1 A7:1 A99:1 A311:1

Sets: 1: {A1, A7, A99, A311}

Note that there are no more match pairs in partition 2 as a result of the merge operation. Optionally, partitions that become empty as a result of a merge operation, such as partition 2 in this example, can be designated as an available partition for processing of future match records and re-used, although it is not necessary to do so.

### Step 3

Finally, in Step 3, the partition identifiers determined by Step 2 are written back into all the source data records in Data Set A as unique entity identifiers. Based on the matching process and the subsequent partitioning process, we know that there is one unique entity represented in the original source record set for each partition identifier that has been produced. Therefore, in the preferred embodiment, the partition number can be used as a unique assigned entity identifier. However in other embodiments, it is also possible to map the partition identifier to other entity identifiers, or alternatively, to derive an identifier from some selected entity data present in the sparse data records in the same set.

Once these write operations are complete, all the original source records are designated with the particular entity identifier to which they associate. These write operations can likewise be executed safely in a bulk manner or even highly parallel manner because the resolution of which partition value needs to be written to which record has already been decisively determined during Step 2.

### Partitioning Process Flowchart

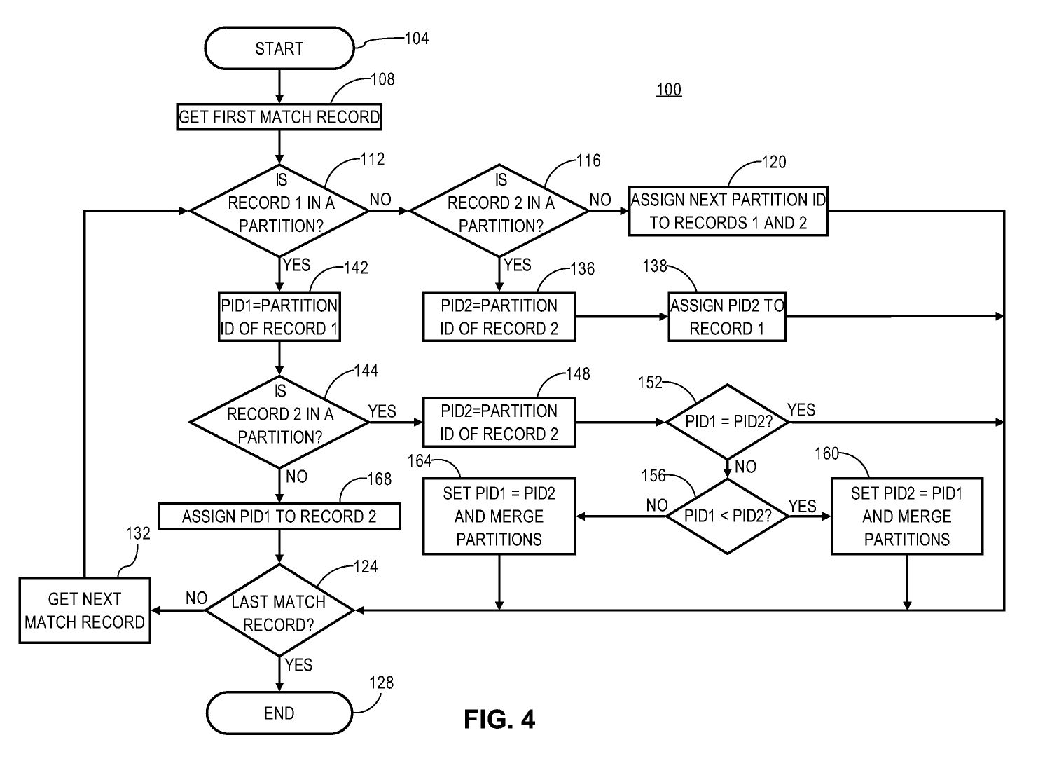

The partitioning process described in Step 2 above is illustrated in the flow chart 100 appearing in FIG. 4. The process starts at step 104 and at step 108 the first match record, comprising a matching pair of records in the data set, designated record 1 and record 2, is obtained. At step 112, it is determined whether record 1 is currently assigned to a partition. If record 1 is not currently assigned to a partition at step 112, the process proceeds to step 116 where it is determined whether record 2 is currently assigned to a partition. If record 2 is not currently assigned to a partition at step 116, the process proceeds to step 120 where records 1 and 2 are assigned the next available partition identifier (partition ID). The process then proceeds to step 124 where it is determined whether the match record just processed is the last match record in the set of confirmed matched as identified in Step 1, above. If the last match record has been processed, the process ends at step 128. If there are still further match record to process, the process proceeds to step 132 where the next match record is obtained and the process returns to step 112 and the process continues.

If, at step 116, it is determined that record 2 is in a partition (i.e., has been assigned a partition ID), then the process proceeds to step 136 where the partition ID of record 2 defines a value (“PID2” in the illustrated example), and that value is assigned as the partition identifier for record 1 at step 138. The process then continues to step 124 and continues as described above.

If, at step 112, it is determined that record 1 is in a partition, the process proceeds to step 142 where the partition ID of record 1 defines a value (“PID1” in the illustrated example). The process then proceeds to step 144, where it is determined whether record 2 of the match record currently being processes is also in a partition. If at step 144, record 2 is not in a partition 2, then the value PID1 is assigned as the partition identifier for record 2 at step 168. The process then continues to step 124 and continues as described above.

If, at step 144, it is determined that record 2 is in a partition (i.e., has been assigned a partition ID), then the process proceeds to step 148 where the partition ID of record 2 defines the value PID2. Next, at step 152, the value of PID2 is then compared to the value of PID1 as determined at step 142. If it is determined at step 152 that the partition identifiers of records 1 and 2 are the same, then the process continues to step 124 and continues as described above.

If it is determined at step 152 that the partition identifiers of records 1 and 2 are not the same, then a partition merge is required and the process continues to step 156. At step 156, it is determined which partition value is greater. If PID1 is less than PID2, then the process continues to step 160 and the partition identifier of record 2, as well as all other records that were previously assigned the value PID2, are reassigned the partition ID value PID1, thereby merging the matching records 1 and 2 into the same partition, based on the lower partition value, and also cascading the reassignment across the full set of records that had been previously assigned the PID2 value. The process then proceeds to step 124 and continues as described above.

If, at step 156, it is determined that PID1 is greater than PID2, then the process continues to step 164 and the partition identifier of record 1, as well all other records that were previously assigned the PID1 value, are changed to have the PID2 value of record 2, thereby merging the matching records 1 and 2 into the same partition, again, based on the lower partition value, and also cascading the changes across the full set of records that were previously assigned the PID1 value. The process then proceeds to step 124 and continues as described above.

### Embodiment within Information Handling System

Referring now to FIG. 5, there appears an exemplary information handling system 200 representative of computer-based information handing system which is operable to embody the presently disclosed system and performing the presently disclosed method. It will be recognized that the system and method herein could be implemented as a module or function within another software application. The hardware system 200 appearing in FIG. 5 is generally representative of a computer-based information handling system, such as a PC, workstation, a mini-computer, mainframe computer, or the like.

The hardware system 200 includes a central processing system 230, a memory 232, one or more storage devices 234, including main and auxiliary memory, an input/output (I/O) system 236, a network interface 238, a communications interface 240, and a display system 242 operably connected by a bus 244.

The hardware system 200 is controlled by the central processing system 230, which may include a central processing unit such as a microprocessor or microcontroller for executing programs, performing data manipulations and controlling the tasks of the hardware system. The processor 230 can be any suitable Intel, AMD, Motorola, Texas Instruments, or Sun processor, or the like. Communication with the central processor 230 is implemented through the system bus 244 for transferring information among the components of the hardware system.

The memory 232 provides storage of instructions and data for programs executing on the central processing system 230. The memory 232 is typically semiconductor-based memory as would be generally understood by persons skilled in the art. The storage devices 234 may include semiconductor-based memory such as read-only memory (ROM), programmable read-only memory (PROM), erasable programmable read-only memory (EPROM), electrically erasable programmable read-only memory (EEPROM), flash memory, and so forth. The storage devices 234 may also include a variety of non-semiconductor-based memories, including but not limited to hard disk, floppy disc, compact disc read-only memory (CD-ROM), digital versatile disc read-only memory (DVD-ROM), and so forth.

The display system 242 may comprise a display device and a video display adapter having the components for driving a display device, including video memory, buffer, and graphics engine as desired. The display device may comprise a video monitor such as a cathode ray-tube (CRT) display, liquid-crystal display (LCD), light-emitting diode (LED) display, gas or plasma display, and so forth.

The input/output (I/O) system 236 may comprise one or more controllers or adapters for providing interface functions between one or more I/O devices. The input/output system 236 may comprise one or more serial ports, parallel ports, universal serial bus (USB) ports, IEEE 1394 ports, infrared ports, etc., for interfacing with corresponding I/O devices such as a keyboard, mouse/pointing device, printer, modem, microphone, speaker, and so forth.

The network interface 238 may be connected to a network to communicate with other computers, external devices, networks, or information sources on the network 190. The network interface 238 may be a network adapter implementing, for example, IEEE 802 network standards (e.g., IEEE 802.3 for Ethernet networks, IEEE 802.11 for wireless networks, IEEE 802.15 for personal area networks, IEEE 802.16 for broadband wireless metropolitan networks, and so on.).

The communications interface 240 may be connected to a network, such as the Internet for communication with other computers or devices using an ISP and/or a dial up phone system to connect to the network. The communications interface 240 can be a modem, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that the hardware system 200 of FIG. 5 is illustrative and exemplary only.

The systems and methods disclosed herein can be implemented as sets of instructions resident in the main memory of one or more computer systems. Until required by the computer system, the set of instructions may be stored in another computer readable memory such as a hard disk drive or in a removable memory such as an optical disk for utilization in a DVD-ROM or CD-ROM drive, a magnetic media for utilization in a magnetic media drive, a magneto-optical disk for utilization in a magneto-optical drive, or a memory card for utilization in a memory card slot. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored, e.g., electrically, magnetically, chemically, physically, or optically, so that the medium carries computer readable information.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A computer-implemented method for partitioning records in a data set, each record having one or more data elements, the method comprising:
comparing the records to identify pairs of matching records in the data set, wherein records within each pair of matching records are representative of a common entity;
assigning each matching record to a unique partition wherein said unique partition contains all matching records and does not overlap with any other partition; and
updating each record with a partition identifier representative of said unique partition.

2. The method of claim 1, further comprising:
for each of said pairs of matching records, storing a match record comprising a record identifier associated with each record in the pair of matching records.

3. The method of claim 2, wherein said step of assigning each matching record to a unique partition comprises, for each match record, the steps of:
(a) determining whether a first one of the record identifiers in the match record represents a record that has previously been assigned to a partition;
(b) if the first one of the record identifiers in the match record does not represent a record that has previously been assigned to a partition, determining whether a second one of the record identifiers in the match record represents a record that has previously been assigned to a partition; and
(c) if the second one of the record identifiers in the match record does not represent a record that has previously been assigned to a partition, assigning an available partition identifier to both of the first one of the record identifiers in the match record and the second one of the record identifiers in the match record.

4. The method of claim 3, wherein the available partition identifier is a lowest numeric identifier and is selected from a plurality of available numeric identifiers.

5. The method of claim 2, wherein said step of assigning each matching record to a unique partition comprises, for each match record, the steps of:
(a) determining whether a first one of the record identifiers in the match record represents a record that has previously been assigned to a partition;
(b) if the first one of the record identifiers in the match record represents a record that has previously been assigned to a partition, determining whether a second one of the record identifiers in the match record represents a record that has previously been assigned to a partition; and
(c) if the second one of the record identifiers in the match record does not represent a record that has previously been assigned to a partition, assigning a partition identifier to the second one of the record identifiers in the match record which is equal to the partition identifier previously assigned to the first one of the record identifiers in the match record.

6. The method of claim 2, wherein said step of assigning each matching record to a unique partition comprises, for each match record, the steps of:
(a) determining whether a first one of the record identifiers in the match record represents a record that has previously been assigned to a partition;
(b) if the first one of the record identifiers in the match record does not represent a record that has previously been assigned to a partition, determining whether a second one of the record identifiers in the match record represents a record that has previously been assigned to a partition; and
(c) if the second one of the record identifiers in the match record represents a record that has previously been assigned to a partition, assigning a partition identifier to the first one of the record identifiers in the match record which is equal to the partition identifier previously assigned to the second one of the record identifiers in the match record.

7. The method of claim 2, wherein said step of assigning each matching record to a unique partition comprises, for each match record, the steps of:
(a) determining whether a first one of the record identifiers in the match record represents a record that has previously been assigned to a partition;
(b) if the first one of the record identifiers in the match record represents a record that has previously been assigned to a partition, determining whether a second one of the record identifiers in the match record represents a record that has previously been assigned to a partition;
(c) if the second one of the record identifiers in the match record represents a record that has previously been assigned to a partition, determining whether the record represented by the first one of the record identifiers and the record represented by the second one of the record identifiers are assigned to the same partition; and
(d) if the record represented by the first one of the record identifiers and the record represented by the second one of the record identifiers are assigned to different partitions, merging the different partitions into a single partition, by setting a partition identifier of a first one of the different partitions to be equal to a partition identifier of a second one of the different partitions.

8. The method of claim 7, wherein the partition identifier of the first one of the different partitions and the partition identifier of the second one of the different partitions are numeric identifiers and wherein the step of merging the different partitions into a single partition comprises:
if the first one of the different partitions has a partition identifier that is less than a partition identifier of the second one of the different partitions, assigning the partition identifier of the first one of the different partitions to the second one of the different partitions; and
if the first one of the different partitions has a partition identifier that is greater than a partition identifier of the second one of the different partitions, assigning the partition identifier of the second one of the different partitions to the first one of the different partitions.

9. The method of claim 1, wherein the records in each pair of matching records have one or more matching data elements.

10. The method of claim 1, wherein the step of comparing the records comprises:
identifying one or more match candidates;
assigning a score to each of the one or more match candidates, the score representative of a likelihoods that the records in the match candidate resolve to a common entity; and
determining whether each score meets a preselected threshold value and, if so, generating a match record.

11. The method of claim 1, wherein the step of comparing the records to identify pairs of matching records in the data set is performed without writing any data back to the records.

12. The method of claim 1, wherein the records contain data elements representative of entities selected from the group consisting of a business entities, employers, or both.

13. A computer-based information handling system for resolving and partitioning matching records in a data set, the system comprising:
a processor;
a memory in electronic communication with the processor; and
instructions stored in said memory, the instructions being executable to:
compare the records to identify pairs of matching records in the data set, wherein records within each pair of matching records are representative of a common entity;
assign each matching record to a unique partition wherein said unique partition contains all matching records and does not overlap with any other partition; and
update each record with a partition identifier representative of said unique partition.

14. The computer-based information handling system of claim 13, the instructions further executable to, for each of said pairs of matching records, store in the memory a match record comprising a record identifier associated with each record in the pair of matching records.

15. The computer-based information handling system of claim 14, the instructions further executable, for each match record, to:
(a) determine whether a first one of the record identifiers in the match record represents a record that has previously been assigned to a partition;
(b) if the first one of the record identifiers in the match record does not represent a record that has previously been assigned to a partition, determine whether a second one of the record identifiers in the match record represents a record that has previously been assigned to a partition; and
(c) if the second one of the record identifiers in the match record does not represent a record that has previously been assigned to a partition, assign an available partition identifier to both of the first one of the record identifiers in the match record and the second one of the record identifiers in the match record.

16. The computer-based information handling system of claim 15, wherein the partition identifier is a numeric identifier and the available partition identifier is a lowest available numeric identifier.

17. The computer-based information handling system of claim 14, the instructions further executable, for each match record, to:
(a) determine whether a first one of the record identifiers in the match record represents a record that has previously been assigned to a partition;
(b) if the first one of the record identifiers in the match record represents a record that has previously been assigned to a partition, determine whether a second one of the record identifiers in the match record represents a record that has previously been assigned to a partition; and
(c) if the second one of the record identifiers in the match record does not represent a record that has previously been assigned to a partition, assign a partition identifier to the second one of the record identifiers in the match record which is equal to the partition identifier previously assigned to the first one of the record identifiers in the match record.

18. The computer-based information handling system of claim 14, the instructions further executable, for each match record, to:
(a) determine whether a first one of the record identifiers in the match record represents a record that has previously been assigned to a partition;
(b) if the first one of the record identifiers in the match record does not represent a record that has previously been assigned to a partition, determine whether a second one of the record identifiers in the match record represents a record that has previously been assigned to a partition; and
(c) if the second one of the record identifiers in the match record represents a record that has previously been assigned to a partition, assign a partition identifier to the first one of the record identifiers in the match record which is equal to the partition identifier previously assigned to the second one of the record identifiers in the match record.

19. The computer-based information handling system of claim 14, the instructions further executable, for each match record, to:
(a) determine whether a first one of the record identifiers in the match record represents a record that has previously been assigned to a partition;
(b) if the first one of the record identifiers in the match record represents a record that has previously been assigned to a partition, determine whether a second one of the record identifiers in the match record represents a record that has previously been assigned to a partition;
(c) if the second one of the record identifiers in the match record represents a record that has previously been assigned to a partition, determine whether the record represented by the first one of the record identifiers and the record represented by the second one of the record identifiers are assigned to the same partition; and
(d) if the record represented by the first one of the record identifiers and the record represented by the second one of the record identifiers are assigned to different partitions, merge the different partitions into a single partition by setting a partition identifier of a first one of the different partitions to be equal to a partition identifier of a second one of the different partitions.

20. The computer-based information handling system of claim 19, wherein the partition identifier of the first one of the different partitions and the partition identifier of the second one of the different partitions are numeric identifiers and wherein the step of merging the different partitions into a single partition comprises:
if the first one of the different partitions has a partition identifier that is less than a partition identifier of the second one of the different partitions, assigning the partition identifier of the first one of the different partitions to the second one of the different partitions; and
if the first one of the different partitions has a partition identifier that is greater than a partition identifier of the second one of the different partitions, assigning the partition identifier of the second one of the different partitions to the first one of the different partitions.

21. The computer-based information handling system of claim 13, wherein the records in each pair of matching records have one or more matching data elements.

22. The computer-based information handling system of claim 13, wherein the instructions are executable to compare the records by:
identifying one or more match candidates;
assigning a score to each of the one or more match candidates, the score representative of a likelihoods that the records in the match candidate resolve to a common entity; and
determining whether each score meets a preselected threshold value and, if so, generating a match record.

23. The computer-based information handling system of claim 13, wherein the instructions are executable to identify pairs of matching records in the data set is performed without modifying the records.

24. A computer-implemented method for partitioning records in a data set, each record having one or more data elements, the method comprising:
comparing the records to identify pairs of matching records in the data set, wherein records within each pair of matching records are representative of a common entity;
for each of said pairs of matching records, storing a match record comprising a record identifier associated with each record in the pair of matching records;
storing each of said pairs of matching records as a match record comprising a record identifier associated with each record of said pair of matching records;
assigning each matching record to a unique partition wherein said unique partition contains all matching records and does not overlap with any other partition, wherein said step of assigning each matching record to a unique partition comprises, for each match record, the steps of:
(a) determining whether a first one of the record identifiers in the match record represents a record that has previously been assigned to a partition;
(b) if it is determined in step (a) that the first one of the record identifiers in the match record does not represent a record that has previously been assigned to a partition, determining whether a second one of the record identifiers in the match record represents a record that has previously been assigned to a partition;
(c) if it is determined in step (b) that the second one of the record identifiers in the match record does not represent a record that has previously been assigned to a partition, assigning an available partition identifier to both of the first one of the record identifiers in the match record and the second one of the record identifiers in the match record;
(d) if it is determined in step (a) that the first one of the record identifiers in the match record represents a record that has previously been assigned to a partition, determining whether a second one of the record identifiers in the match record represents a record that has previously been assigned to a partition;
(e) if it is determined in step (d) that the second one of the record identifiers in the match record does not represent a record that has previously been assigned to a partition, assigning a partition identifier to the second one of the record identifiers in the match record which is equal to the partition identifier previously assigned to the first one of the record identifiers in the match record;
(f) if it is determined in step (b) that the second one of the record identifiers in the match record represents a record that has previously been assigned to a partition, assigning a partition identifier to the first one of the record identifiers in the match record which is equal to the partition identifier previously assigned to the second one of the record identifiers in the match record;
(g) if it is determined in step (d) that the second one of the record identifiers in the match record represents a record that has previously been assigned to a partition, determining whether the record represented by the first one of the record identifiers and the record represented by the second one of the record identifiers are assigned to the same partition;
(h) if it is determined in step (g) that the record represented by the first one of the record identifiers and the record represented by the second one of the record identifiers are assigned to different partitions, merging the different partitions into a single partition by setting a partition identifier of a first one of the different partitions to be equal to a partition identifier of a second one of the different partitions.
